(19) United States
(12) Patent Application Publication
(10) Pub. No.: US 2026/0356667 A1
(43) Pub. Date: Nov. 12, 2026

(54) HYDROGEN PROCESS AND PLANT

(71) Applicant: CASALE SA, Lugano (CH)

(72) Inventors: Pietro MOREO, Lugano (CH); Fabio SASSI, Vedano Olona (VA) (CH)

(21) Appl. No.: 19/135,221

(22) PCT Filed: Dec. 7, 2023
(86) PCT No.: PCT/EP2023/084772

§ 371 Date: Jun. 3, 2025

(30) Foreign Application Priority Data
Dec. 12, 2022 (EP) 22212907.4

(51) Int. Cl. C01B 3/36; C01B 3/48; C01B 3/501; C01B 3/506; C01B 3/56

(52) U.S. Cl. CPC C01B 3/36; C01B 3/48; C01B 3/501; C01B 3/506; C01B 3/56; C01B 2203/0211; C01B 2203/0227; C01B 2203/0405; C01B 2203/042; C01B 2203/046; C01B 2203/0475; C01B 2203/1258; C01B 2203/143; C01B 2203/146; C01B 2203/148

(57) ABSTRACT

A process and a plant for the synthesis of hydrogen comprising a reforming section for producing syngas and a post-processing section for producing hydrogen wherein the reforming section includes an autothermal reformer and a gas-heated reformer arranged in parallel wherein heat is transferred from the autothermal reformer to the gas-heated reformer and the post-processing section includes a hydrogen purification section for the separation of hydrogen from a tail gas and the plant further includes a line for recycling the tail gas back to reforming section.

### FIELD OF APPLICATION

The invention is in the field of hydrogen synthesis. The invention particularly pertains to a process and a plant for the production of hydrogen from natural gas (NG).

### PRIOR ART

In most cases, the production of hydrogen starts with the production of syngas which is obtained by treating a hydrocarbon feedstock in a reforming section which includes a pre-reformer reactor and an autothermal reformer or in alternative a steam reformer.

Syngas, also referred to as synthesis gas, is a gas mixture comprising carbon monoxide CO, hydrogen H₂ and small amounts carbon dioxide CO₂ and methane CH₄.

In hydrogen plants the so obtained syngas is subjected to dedicated treatments including water gas shift conversion wherein CO is converted to CO₂ and H₂ in presence of water, and hydrogen purification wherein hydrogen is separated from unconverted compounds e. g CO, CO₂ and CH₄.

Hydrogen plants based on reforming technologies are also provided with one or more fired heater(s) which is/are used to fulfill the thermal duties of the plant, e.g., by supplying heat to the pre-reformer and to the autothermal reformer feed streams.

In the art there is a growing interest in minimizing the carbon dioxide emission of the hydrogen plants especially in view of the continuously evolving regulations concerning the emission of greenhouse gas.

Several solutions are available to reduce the carbon dioxide emissions from a hydrogen plant but the most commonly applied solution is to capture the carbon dioxide from the synthesis gas and to store the sequestrated CO₂ underground.

Unfortunately, the carbon dioxide sequestrated from the synthesis gas only addresses a limited fraction of the total carbon dioxide emissions of the plant In practice, the CO₂ emitted from the plant is the sum of several contributions including the CO₂ generated by the chemical conversion of the hydrocarbons into syngas but also the CO₂ generated by the operation of the auxiliary systems of the plant, e.g., of the fired heater(s). This later contribution is not negligible and is seldom taken into consideration in the art.

WO 2022/038089 A1, US 2022/194789 A1, and US 2015/129806 A1 disclose known processes and plants comprising hydrogen production stages

### SUMMARY OF THE INVENTION

The invention aims to overcome the above drawbacks of the prior art. In particular, the present invention aims at reducing the CO₂ emission from hydrogen plants.

Accordingly, one aspect of the present invention is a plant for the synthesis of hydrogen according to claim 1.

The plant comprises a reforming section for producing a synthesis gas from conversion of a hydrocarbon feedstock and a post-processing section for sequestering carbon dioxide from the synthesis gas and producing hydrogen.

The reforming section is fed with a hydrocarbon feedstock which is split into a first feedstock portion and into a second feedstock portion. The first feedstock portion is supplied to an autothermal reformer whilst the second feedstock portion is supplied to a gas-heated reformer. The autothermal reformer and the gas heated reformer are arranged in parallel and heat is transferred from the autothermal reformer to the gas-heated reformer and the synthesis gas output of the reforming section is treated in a post-processing unit including a hydrogen purification unit.

Outputs of the hydrogen purification unit are hydrogen having a purity greater than 95% and a tail gas containing unconverted carbon oxides e.g. CO, CO₂, and methane. To tackle the CO₂ emission of the hydrogen plant, a portion (preferably: the main portion) of the tail gas generated in the post-processing unit is recycled as a feed to the gas-heated reformer and/or to the autothermal reformer.

A further aspect of the invention is a process for the synthesis of hydrogen according to the claims.

The invention provides an efficient way to produce high purity hydrogen from synthesis gas meanwhile keeping the emissions of greenhouse gases (carbon dioxide or methane) from the plant as low as possible.

The invention has the following advantages.

The recycling of the tail upstream of the reforming section, i.e., to the gas heater reformer and/or to the autothermal reformer, allows operating the hydrogen plant with a low steam-to-carbon ratio (S/C ratio) since it is no longer required to reach a low slip of carbon monoxide and methane from the reforming section Further steam might be injected at water gas shift section inlet to boost the CO conversion. Advantageously, the oxygen consumption of the autothermal reformer is reduced.

Another advantage of the invention is that the sources of carbon generated in the process are eliminated in the post-processing stage of the plant, i.e. in the carbon dioxide removal unit and in the hydrogen purification unit. In the hydrogen purification unit, a tail gas is separated from hydrogen and the separated tail is then recycled back to the reforming section as a feed to avoid carbon dioxide emission.

In a preferred embodiment of the invention a pre-reformer is arranged upstream of the autothermal reformer and upstream of the gas-heated reactor and the S/C ratio at the inlet of the pre-reformer is preferably kept to a value not greater than 1.5, preferably comprised from 0.5 to 1.5, and even more preferably comprised from 0.6 to 0.9 or 0.7 to 0.9, for example of around 0.8. In addition, steam can also be injected at inlet of the gas-heated reformer to achieve a steam to carbon ratio greater than 2 typically around 5.

In addition, further steam may also be injected upstream water gas shift section in order to reach an oxygen to carbon ratio (O/C ratio) preferably in the range 2.25 to 3 and even more preferably between 2.25 and 2.5.

The possibility to operate with a low S/C ratio at the inlet of the pre-reformer together with the provision of a gas heater reformer in parallel with the autothermal reformer allows to decrease the duty of the fired-heater which is used to provide steam as a heating source to the reforming section by about 20% and, when an air separation unit ASU is used to supply oxygen to the autothermal reformer, the size of the ASU can be reduced by 8%.

Further when the heat generated by the autothermal reformer is exploited to heat the hydrocarbon feedstock which is converted in the gas-heated reformer, it is further possible to reduce the duty of the fired-heater by another 20%.

The fact that the duty of the fired-heater is decreased leads to a reduced carbon intensity of the present process and plant.

In practice the present invention allows to reduce the duty of the fired heater, the size of the ASU and recycle most of the unconverted carbon back to process. Overall, the emissions of CO₂ from the plant are reduced and the efficiency of the plant is increased. Further also the Capex of the plant are reduced as consequence of the reduction in size of the ASU and the fired heater

According to a further advantageous aspect of the plant and process of the present invention, the recycle of the tail gas as a feed to the gas-heated reformer and/or to the autothermal reformer, the parallel arrangement of the autothermal reformer and of the gas-heated reformer, and the intimate mixing of the streams of synthesis gas performed in this latter, allow to achieve high conversions of the hydrocarbon feedstock without the drawback of increasing carbon dioxide emissions.

These advantages are especially tangible when the ATR is operated at low S/C ratios (e.g., comprised from 0.7 to 0.9). These S/C ratios are not used in once through systems equipped with a primary reformer followed by an ATR in series, which require higher S/C ratios (from 2 to 4) and lead to consequent higher carbon intensity.

Thanks to the invention, a high purity hydrogen is produced and the carbon intensity of the process can be reduced to a desirable value of 0.1 kg CO₂/kg H₂.

### DESCRIPTION OF THE INVENTION

The hydrogen plant comprises a reforming section configured to convert a hydrocarbon feedstock into a synthesis gas Preferably, the hydrocarbon feedstock is natural gas.

The reforming section comprises an autothermal reformer and a gas-heated reformer arranged in parallel. The autothermal reformer is arranged to receive a first feedstock portion of a hydrocarbon feedstock to generate a first stream of synthesis gas under autothermal reforming conditions.

The gas-heated reformer has a reaction vessel that includes a first side and a second side whereas the first side is arranged to receive a second portion of the hydrocarbon feedstock. The first side may contain a catalyst for conversion of the feedstock into synthesis gas. The first side can be a tube side of the gas-heated reformer, which can include a catalyst, to generate a second stream of synthesis gas. The second side of the gas heater reformer can be a shell side of the reformer which can be arranged to surround the tube side.

The first side and the second side are arranged so that a fluid traversing the first side can exchange heat with a fluid traversing the second side. Particularly, in operation, heat is transferred from a fluid in the second side (hot side) to a fluid in the first side. The first side is in fluid communication with the second side so that the synthesis gas effluent of the first side enters into the second side. The second side of the reformer is supplied, together with the synthesis gas effluent of the first side, with the synthesis gas output of the autothermal reforming section so as to mix with the synthesis gas of this latter and thereby generate a combined synthesis gas in the second side. The combined synthesis gas is the output of the reforming section of the plant.

The syngas output of the reforming section is then treated in a post-treatment section including a water gas shift reactor, a carbon dioxide removal unit and a hydrogen purification unit. The hydrogen purification unit is arranged to separate hydrogen from a tail gas comprising unconverted carbon oxides, e.g. CO, CO₂, and CH₄.

The plant further includes at least one line arranged to recycle the tail gas as a feed to the gas-heated reformer and/or as a feed to said autothermal reformer.

The hydrogen produced from the plant has a high purity preferably higher than 95% and more preferably higher than 99%. Said hydrogen can be used as a reagent for the synthesis of ammonia and/or methanol and, according to an embodiment, the hydrogen plant of the invention can be integrated with an ammonia plant and/or with a methanol plant or with both.

According to a particularly interesting embodiment of the invention, the reforming section further includes a pre-reformer arranged upstream of said autothermal reformer and upstream of said gas-heated reformer. Accordingly, the autothermal reformer and the gas-heated reformer are fed with a partially reformed gas which includes unconverted hydrocarbons i.e. methane.

The plant can also be integrated with a desulfurization unit and/or a natural gas purification unit arranged upstream the pre-reformer and used to remove sulfur and/or other possible catalyst poisons for the hydrocarbon feedstock which is supplied to the pre-reformer The desulfurization unit is preferably a catalytic reactor.

The plant may further include a recycling line arranged to recycle at least a portion of the tail gas extracted from the hydrogen separator unit upstream of the desulfurization unit.

Preferably the hydrogen purification unit is one of the following: a pressure swing absorption unit, a cryogenic separation unit or a membrane separator, preferably a pressure swing absorption unit.

The plant preferably further includes an air separation unit ASU arranged to provide oxygen to the autothermal reformer. Preferably, the autothermal reformer is an oxygen-fired autothermal reformer.

The plant can further include a first heat exchanger arranged upstream of pre-reformer and/or a second heat exchanger arranged upstream of said gas-heated reformer. The first heat exchanger and the second heat exchanger can be used to pre-heat said feedstock portion of hydrocarbon feedstock supplied to the reformers. The duty required by such heat exchangers is supplied by the hot fluid exiting the hot side of the gas heated reformer prior that such gas is supplied to the heat recovery section.

According to a particularly interesting application, the plant further includes a heat recovery section arranged downstream said reforming section and upstream of said post-treatment section. The heat recovery section can include a waste heat boiler arranged to recover heat from the synthesis gas output of the reforming section generating steam as a by-product.

The steam generated can be used to partially fulfil the thermal duty of the plant or in alternative the steam produced may be further superheated in a fired-heater and afterward exploited in the plant as processing medium for power generation e.g. in a steam turbine.

The plant preferably includes one or more fired heater(s) used to fulfil the thermal duty of the plant. The fired heater can be used to supply heat to the hydrodesulfurization reactor, to the pre-reformer reactor, to the gas heated reformer and to the autothermal reformer feed streams and to superheat the steam generated in the heat recovery section.

In some embodiments, the plant further includes a falling film saturator arranged downstream of the waste heat boiler and configured to supply all or part of the process steam to the pre-reformer. Said falling film saturator is configured for evaporating process condensate, or fresh water, or process condensate and fresh water. More precisely, in the falling film saturator a natural gas stream enters from below and liquid water enters from above, forming a film inside a plurality of pipes of said saturator. The hot effluent stream of the GHR provides (preferably after passing through a waste heat boiler) the heat necessary for the evaporation of the water in said pipes, in order to produce a water saturated stream.

Another object of the invention is a process for the production of hydrogen. The process comprises to provide a hydrocarbon feedstock and to split the hydrocarbon feedstock into a first feedstock portion and into a second feedstock portion.

The process includes a reforming process carried out on the hydrocarbon feedstock to generate a synthesis gas. The reforming process includes an autothermal reforming step and a gas-heated reforming step carried out in parallel.

The autothermal reforming step is performed on the first feedstock portion and the gas heated reforming step is carried out on the second feedstock portion. Heat is transferred from the autothermal reforming step to the gas-heated reforming step.

According to the invention, the synthesis gas output of the autothermal reforming step is mixed with the syngas output of the first side of the gas heated reforming step to generate a combined synthesis gas stream. Heat transfer from the ATR to the gas-heated reformer is achieved by allowing the combined synthesis gas to flow in the second side of the gas heated reformer.

Preferably the shell side of the gas-heated reformer surrounds the tube side of the reformer so that when the combined synthesis gas traverses the second side of the reformer, heat is transferred from the combined synthesis gas to the first portion of hydrocarbons which undergoes reforming in the first side of the gas heated reforming.

The process further includes to subject the synthesis gas output of the gas heated reforming step to a post-treatment process which comprises a water gas shift conversion, a carbon dioxide removal step and a hydrogen purification step.

The hydrogen purification step generates hydrogen and a tail gas comprising carbon monoxide and carbon dioxide and residual hydrogen. The tail gas is recycled as a feed to the gas-heated reforming step and/or to the autothermal reforming step.

According to a preferred embodiment, said first feedstock portion is comprised from 80 to 98 vol % of the entire hydrocarbon feedstock treated in the reforming section.

According to a preferred embodiment, the amount of tail gas recycled as a feed to the gas-heated reformer is comprised from 10 to 100 vol % of the entire tail gas generated in said hydrogen purification step.

According to a particularly interesting embodiment of the invention, the reforming process is preceded by a hydrodesulfurization step and by an adiabatic pre-reforming step. The adiabatic pre-reforming step is preferably carried out on a hydrocarbon feedstock which has been de-sulphurised.

Preferably, the output of the pre-reformer which is a partially reformed gas that includes unconverted hydrocarbons. The pre-reformed gas can then be split into a first and a second stream which are then subjected to the above-described reforming process.

Preferably, the steam to carbon ratio (S/C ratio) at the inlet of the adiabatic pre-reforming step is not greater than 1.5, preferably comprised from 0.5 to 1.5, and even more preferably comprised from 0.6 to 0.9 or 0.7 to 0.9, for example of around 0.8. In addition, steam can also be injected at inlet of the gas-heated reformer to achieve a steam to carbon ratio greater than 2 typically around 5.

According to an embodiment of the invention, a portion of the tail gas obtained from the hydrogen purification step is recycled upstream of the hydrodesulfurization step.

Preferably the portion of tail gas which is recycled upstream of the hydrodesulfurization step is comprised from 1 to 15 vol % of the tail gas generated in the hydrogen purification step.

The synthesis gas output of the reforming section is preferably used to indirectly heat the hydrocarbon feedstock or the pre-reformed gas which is supplied to the autothermal reformer and/or of the gas-heated reformer.

In an embodiment, steam is injected upstream of said gas-heated reforming step to achieve a steam to carbon ratio at the inlet of the gas-heated reformer higher than 2 and preferably higher than 5.

In addition, further steam may also be injected upstream water gas shift section in order to reach an O/C ratio preferably in the range 2.25 to 3 and even more preferably between 2.25 and 2.5.

According to a particularly interesting embodiment, about 90% of the entire hydrocarbon feedstock treated in the reforming section of the plant is sent to the autothermal reformer step and the remaining balance is sent to the gas-heated reformer step. Preferably, the steam to carbon at the inlet of the preformer is lower than 1, more preferably of about 0.8.

Preferably about 90% of the entire tail gas produced in the hydrogen purification step is recycled at the inlet of the ATR inlet and the balance is sent back either to the desulfurization unit or to the gas heater reformer or both. In this way, the hydrogen content of the ATR feed is maximized and the of carbon deposition and soot formation in the ATR are mitigated.

In some embodiments, the hydrogen recovery unit can be placed after the water shift reactor and upstream of the carbon dioxide recovery unit.

### DESCRIPTION OF THE FIGURES

FIG. 1 shows a plant for the synthesis of hydrogen according to a preferred embodiment of the invention.

FIG. 2 shows a reforming section of the hydrogen plant of the invention.

FIG. 3 is a schematic representation of a plant for the synthesis of hydrogen according to an embodiment of the invention.

FIGS. 4 to 7 show various embodiments of the invention.

### DETAILED DESCRIPTION OF THE PREFERRED EMBODIMENTS

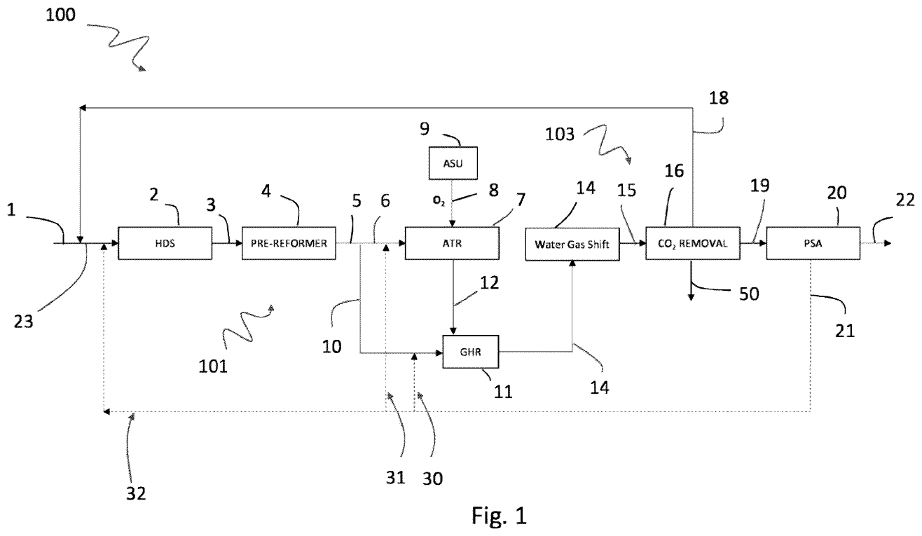

FIG. 1 shows a plant for the synthesis of hydrogen 100 comprising a reforming section 101 and a post-treatment section 103.

The reforming section 101 includes a hydrodesulfurization reactor 2, a pre-reformer 4, an autothermal reformer 7 ATR and a gas-heated reformer GHR 11. The ATR 7 and the GHR 11 are arranged in parallel.

The post-treatment section 103 includes a water gas shift reactor 14, a CO₂ removal unit 16 and a pressure swing absorption unit 20.

The plant operates as follows: a hydrocarbon feedstock 1 consisting of natural gas is supplied to a hydrodesulfurization reactor 2 to generate a desulfurized natural gas stream 3. The desulfurized natural gas stream 3 is pre-reformed in a pre-reformer 4. Output of the pre-reformer 4 is a pre-reformed gas 5 which includes unconverted hydrocarbons e.g. methane. The pre-reformed gas 5 is split into a first portion of pre-reformed gas 6 and into a second portion of pre-reformed gas 10. Preferably the first portion of pre-reformed gas 6 is at least 90% of the entire pre-reformed gas 5.

The first portion of pre-reformed gas 6 is supplied to the ATR 7 together with an oxygen stream 8 generated in an air separation unit 9 Output of the ATR 7 is a first stream of synthesis gas 12.

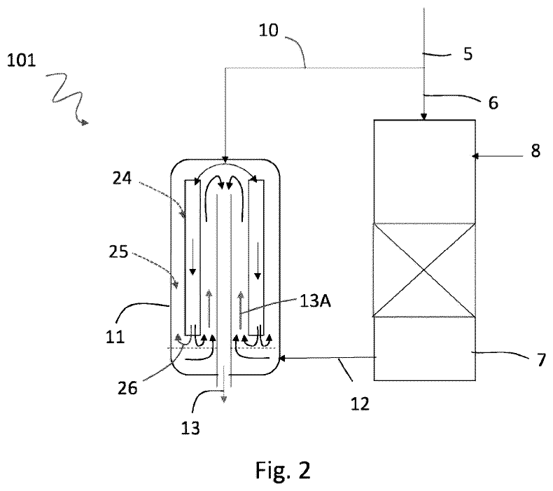

The second portion 10 of pre-reformed gas is supplied to the GHR 11 in a tube side of the GHR to generate a second stream of synthesis gas 26 (shown in FIG. 2). The second stream of synthesis gas 26 is mixed with the first stream of synthesis gas 12 in a shell side of the GHR 11 to obtain the synthesis gas 13A.

In the second side of the GHR 11, stream 13A exchanges heat with the second portion of pre-reformed gas 10 undergoing reforming in the tube side of the reactor. After heat exchange, stream 13A reaches the conditions of stream 13 which is the output of the reforming section.

The synthesis gas 13 is then treated in a water gas shift reactor 14 to obtain a shifted gas 15 rich in hydrogen which is then sent to a CO₂ removal unit 16. Outputs of the CO₂ removal unit 16 is a first stream of carbon dioxide 18 which is recycled back to the hydrodesulfurization reactor 2, a second stream of carbon dioxide 50 which is further sent to compression to be stored underground and a carbon dioxide depleted gas stream 19 which is rich in hydrogen.

The carbon dioxide-depleted gas stream 19 is then treated in pressure swing absorption unit 19 to generate a hydrogen stream 22 and a tail gas 21 which include hydrogen, residual non-converted hydrocarbons, e.g. methane, and carbon monoxide.

A portion of tail gas 21 (preferably a main portion thereof; i.e. >95% vol) can then be recycled as a feed to the gas-heated reformer 11 via line 30 and/or to the autothermal reformer ATR via line 31 and, in some embodiments, to the hydrodesulfurization reactor 2 via line 32. A remaining portion of tail gas 21 can be purged from the system and used as fuel in the fired heater (not shown in the figure).

The plant further includes a fired heater not shown in the figure which is used to supply heat to the hydrodesulfurization reactor 2, to the pre-reformer 4 and to the autothermal reformer 7 and/or to superheat steam generated by the process. The steam superheated by the fired heater can also be conveyed to a steam generator for generating electricity.

The fired heater can also be fed with a portion of the tail gas stream 21 and hydrogen stream 22.

FIG. 2 shows in detail the arrangement configuration of the ATR 7 and the GHR 11.

The autothermal reformer 7 is either supplied whit a first portion of hydrocarbon feedstock 6 or, in a hydrogen plant 100 provided with a pre-reformer, the ATR 7 is supplied with a first portion of pre-reformed gas.

Output of the ATR is the first stream of synthesis gas 12 which is then supplied to the second side 25 of the gas heater reformer 11.

On the contrary, the gas heater reformer 11 is either supplied with a second portion of hydrocarbon feedstock 10 or, in the hydrogen plant 100 provided with a pre-reformer 4, the GHR 11 is supplied with a second portion of pre-reformed gas.

The second portion of hydrocarbon feedstock 10 reacts in the tube side of the reformer to generate a second stream of synthesis gas 26. The latter is mixed with the first stream of synthesis gas 12 to yield a combined synthesis gas 13A in the shell side of the reactor.

Note that the first stream of synthesis gas 12 leaving the ATR 7 has a temperature comprised from 850 °C to 1100 °C and in the invention said gas is mixed with stream 26 to produce stream 13A having a temperature comprised from 800 to 1050 °C. Stream 13A is used to exchange heat with the second portion of hydrocarbon feedstock 10 which undergoes reforming in the tube side of the GHR 11. After heat exchange, stream 13A is cooled to the temperature of stream 13 which is the final output of the reforming section.

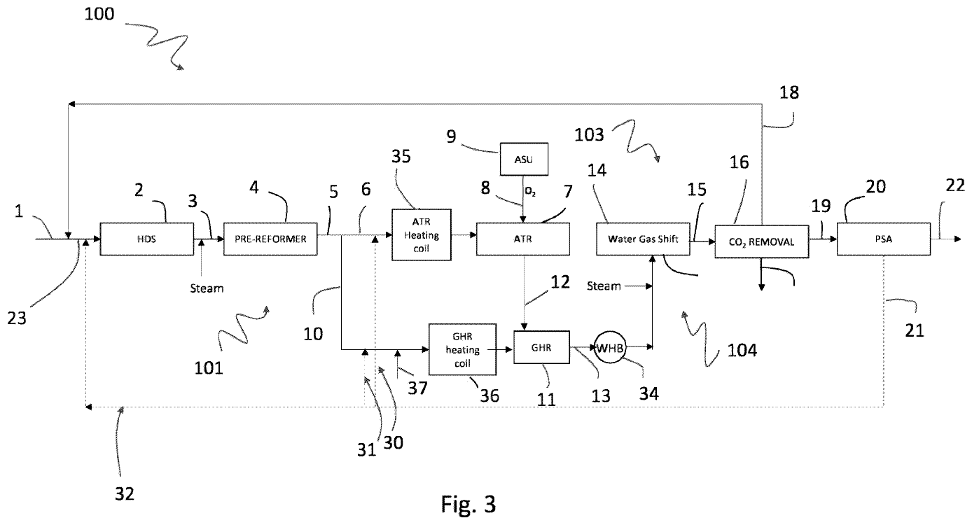

FIG. 3 illustrates an embodiment of the invention wherein the plant further includes a heat recovery section 104 comprising a waste heat boiler WHB 34.

Note that the synthesis gas 13 output of the GHR 11 is cooled in the waste-heated boiler 34 to generate steam. The steam generated in the WHB 34 can be exploited to fulfill the thermal duty of the plant.

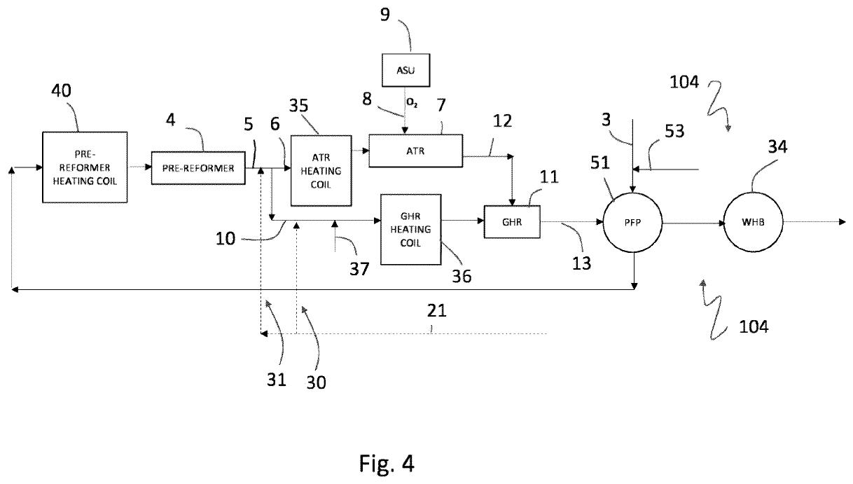

FIG. 4 illustrates another embodiment of the invention wherein the plant 100 further includes a first heat exchanger 51 arranged prior to the pre-reformer 4. The heat exchanger 51 is used to preheat the pre-reformed mixed feed of gas and steam (3, 53) which is supplied to pre-reformer 4. Pre-reformer heating 40 coil may not be present in such embodiment.

Steam can also be injected upstream of the GHR 11 to adjust the S/C ratio at the inlet of the gas-heated reformer 11.

Note that the heat recovery section 104—which is used to recover heat from the synthesis gas 13 in the present embodiment—comprises a waste heat boiler WHB 34 and a heat exchanger 51 which is used to pre-heat a hydrocarbon feedstock 3 and steam 53.

The hydrocarbon feedstock 3 and the steam 53 are mixed and pre-heated in the heat exchanger 51 and may then further be heated in a pre-reformed heat exchanger 40 prior to be reacted in the pre-reformed 4 together with the desulphurized stream 3.

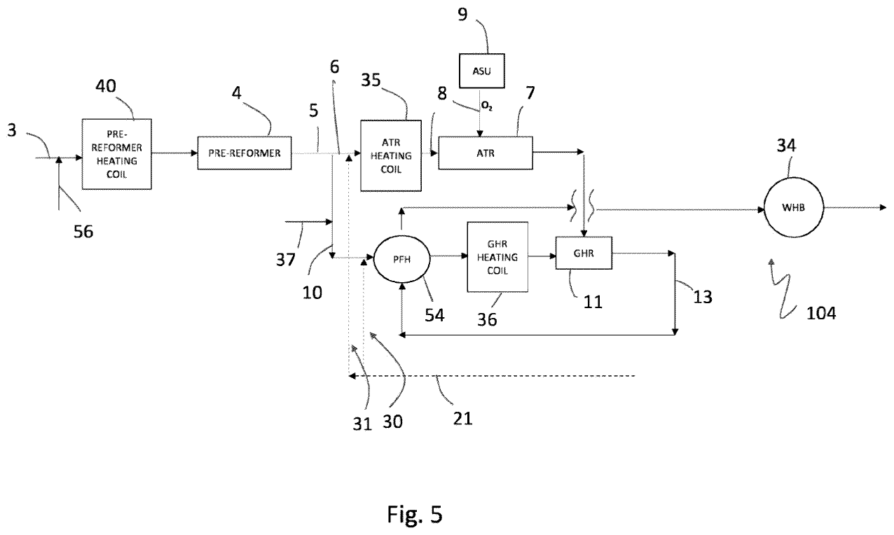

In FIG. 5 it is shown an embodiment wherein the synthesis gas 13 output of the GHR 11 is used to preheat the second portion of pre-reformed gas 10 in the heat exchanger 54. Note that steam 37, 56 can be added prior to the pre-reformer heat exchanger 40 and prior to the heat exchanger 54 to adjust the steam to carbon ratio. GHR heating coil 36 may not be present in this embodiment.

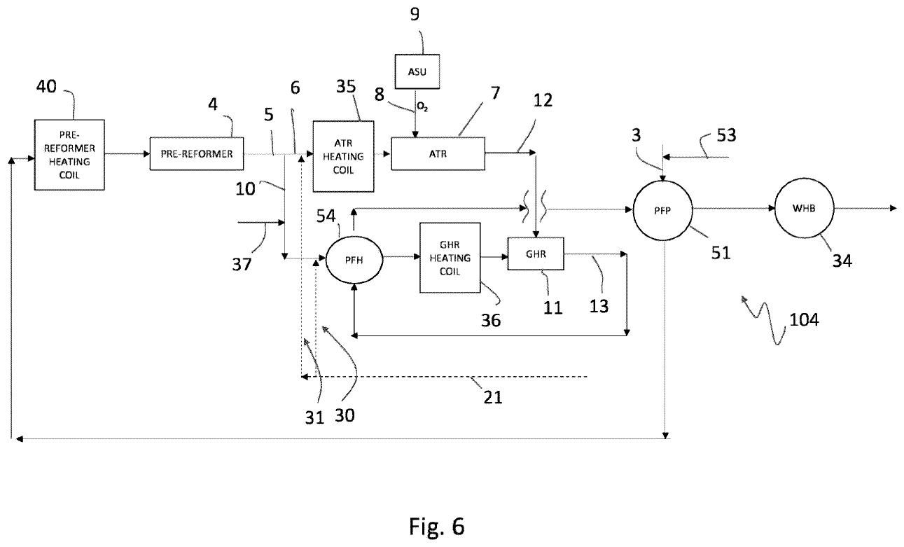

FIG. 6 shows a hydrogen plant that integrates the embodiments illustrated in FIGS. 4 and 5.

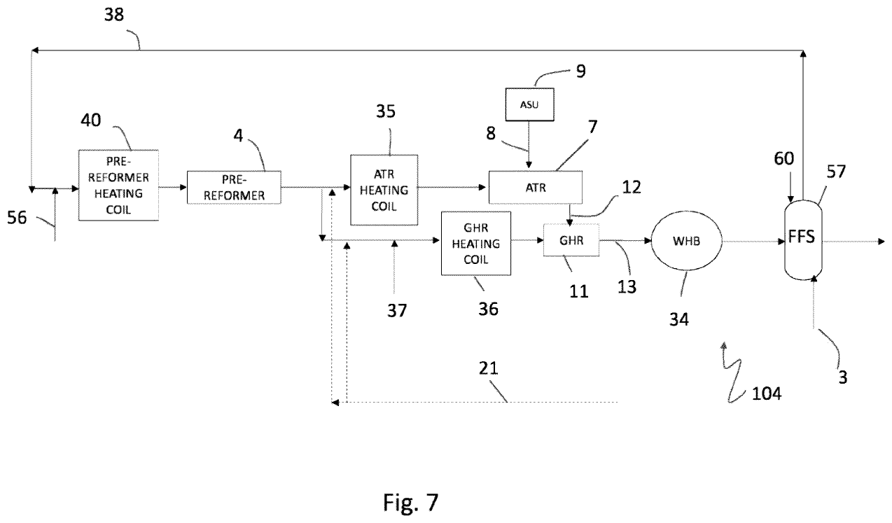

FIG. 7 illustrates a plant configuration wherein the heat recovery section further comprises a falling film saturator (FFS) heat exchanger 57; in the FFS heat exchanger 57 desulfurized natural gas stream 3 is contacted with a stream of water 60 obtaining a mixture containing steam and desulfurized natural gas; this mixture is heated by indirect heat exchange with hot reformed synthesis gas 13. Accordingly, the reformed synthesis gas 13 traverses in series the FFS heat heat exchanger 57, transferring heat to said mixture containing water 60 and natural gas stream 3. The tube side of FFS heat exchanger 57 is fed with the desulfurized hydrocarbon feedstock 3 and water 60. Such water 60 may be process condensate or fresh water. The effluent of WHB 34 can be used to supply the heat required to saturate stream 3 in order to produce the water saturated stream 38. Further steam 56 can be added to stream 38 in order to reach the desired S/C ratio at pre-reformer 4 inlet.

1-17. (canceled)

18. A plant for production of hydrogen, the plant comprising:
a reforming section configured to convert a hydrocarbon feedstock into a synthesis gas, wherein said reforming section includes an autothermal reformer and a gas-heated reformer which are arranged in parallel, and wherein:
said autothermal reformer is arranged to receive a first feedstock portion of said hydrocarbon feedstock and generates a first stream of synthesis gas;
said gas-heated reformer including a first side and a second side, wherein said gas-heated reformer is arranged to receive a second feedstock portion of said hydrocarbon feedstock in said first side and to generate a second stream of synthesis gas in the same side, and said first stream of synthesis gas and said second stream of synthesis gas are mixed in said second side to generate said synthesis gas;
a post-treatment section of said synthesis gas including a water gas shift reactor, a carbon dioxide removal unit and a hydrogen purification unit, said hydrogen purification unit being arranged to separate hydrogen from a tail gas; and
at least one line arranged to recycle said tail gas as a feed to said gas-heated reformer and/or as a feed to said autothermal reformer.

19. The plant according to claim 18, wherein said reforming section further includes a pre-reformer arranged upstream of said autothermal reformer and upstream of said gas-heated reformer.

20. The plant according to claim 19, further comprising a desulfurization unit arranged upstream said pre-reformer and a recycling line arranged to recycle at least a portion of said tail gas upstream said desulfurization unit.

21. The plant according to claim 18, wherein said hydrogen purification unit is one of the following: a pressure swing absorption unit, a cryogenic separation unit, or a membrane separator.

22. The plant according to claim 18, wherein said gas heated reformer is a shell and tube reformer wherein said first side is a tube side and said second side is a shell side.

23. The plant according to claim 18, further comprising an air separation unit arranged to supply an oxygen stream to said autothermal reformer.

24. The plant according to claim 18, further comprising a first heat exchanger arranged upstream of said pre-reformer and configured to pre-heat said hydrocarbon feedstock and steam and/or a second heat exchanger (36) arranged upstream of said gas heated reactor arranged to pre-heat said second feedstock portion of said hydrocarbon feedstock.

25. The plant according to claim 18, further comprising a heat recovery section arranged downstream said reforming section and upstream of said post-treatment section, said heat recovery section includes a waste heat boiler arranged to recover heat from said synthesis gas output of the reforming section.

26. The plant according to claim 18, further comprising a falling film saturator arranged downstream of said waste heat boiler and configured to supply all or part of the process steam to the pre-reformer, said falling film saturator being configured for evaporating process condensate, or fresh water, or process condensate and fresh water.

27. A process for production of hydrogen, the process comprising:
proving a hydrocarbon feedstock and splitting said hydrocarbon feedstock into a first feedstock portion and into a second feedstock portion;
performing a reforming process to generate a synthesis gas, wherein said reforming process comprises an autothermal reforming step and a gas heated reforming step carried out in parallel wherein said autothermal reforming step is performed on said first feedstock portion and said gas heated reforming step is performed on said second feedstock portion, and heat is transferred from said autothermal reforming step to said gas heated reforming step;
subjecting said synthesis gas to a post-treatment including a water gas shift conversion step, a carbon dioxide removal step and a hydrogen purification step, said hydrogen purification step generating a hydrogen stream and a tail gas including carbon monoxide and carbon dioxide and residual hydrogen; and
recycling said tail gas as a feed to at least one of the following: said gas heated reforming step or said autothermal reforming step.

28. The process according to claim 27, wherein said first feedstock portion comprises from 80 to 98 vol % of the hydrocarbon feedstock (5).

29. The process according to claim 27, wherein the amount of tail gas recycled as a feed to the gas heated reformer is comprised from 10 to 100 vol % of the tail gas generated in said hydrogen purification step.

30. The process according to claim 27, wherein the reforming process is preceded by a hydrodesulfurization step and by an adiabatic pre-reforming step.

31. The process according to claim 30, wherein a steam to carbon ratio at the inlet of the adiabatic pre-reforming step is not greater than 1.5.

32. The process according to claim 31, wherein the steam to carbon ratio at the inlet of the adiabatic pre-reforming step 0.5 to 1.5.

33. The process according to claim 27, wherein a portion of the tail gas is recycled upstream of said hydrodesulfurization step,

34. The process according to claim 33 said portion is comprised from 1 to 15 vol % of the tail gas generated in said hydrogen purification step.

35. The process according to claim 27, further comprising to indirectly transfer heat from said synthesis gas output of said reforming process to said first feedstock portion and/or to said second feedstock portion.

36. The process according to claim 27, further comprising injecting steam upstream of said gas heated reforming process to achieve a steam to carbon ratio at the inlet of the gas heated reformer higher than 2, preferably higher than 5.

37. The process according to claim 27, wherein the steam to carbon ratio at the inlet of the gas heated reformer is higher than 5.
